(19) United States
(12) Patent Application Publication
(10) Pub. No.: US 2021/0245273 A1
(43) Pub. Date: Aug. 12, 2021

(54) Milling Machine Scribe Tool

(71) Applicant: Justin Brenton Blanchard, Romeo, MI (US)

(72) Inventor: Justin Brenton Blanchard, Romeo, MI (US)

(21) Appl. No.: 16/789,415

(22) Filed: Feb. 12, 2020

(51) Int. Cl. B23C 3/34; B23Q 15/14; B23C 3/13

(52) U.S. Cl. CPC B23C 3/34; B23C 3/13; B23Q 15/14

(57) ABSTRACT

A scribe tool for use in a 3-axis and 5-axis computer-controlled vector scribe is disclosed. The vector scribe tool is constructed with a shaft having a top end for insertion into a collet of a computer numerical controlled milling machine, a retaining collar coupled to a bottom end of the shaft having one or more set screws, and a scribe tool having a tip of the tool capable of scribing an object. The scribe tool is held within the retaining collar using the one or more set screws, and the tip of the tool is positioned at an intersection of a centerline through the retaining collar and a centerline of the top of the tool when inserted into the collet of a computer numerical controlled milling machine.

### TECHNICAL FIELD

This application relates in general to an article of manufacture for providing a vector scribe tool for a 3-axis computer-controlled milling machine.

### BACKGROUND

Machining of objects or parts sometimes requires tools to scribe lines into the objects at precise locations. Typically, a 5-axis milling tool is typically a computer numerical controlled (CNC) milling machine. These machines are more expensive, complicated, and harder to operate that the related 3-axis CNC milling machines. These 3-axis machines are more prevalent than the 5-axis machines. Accurately scribing marks and lines into the objects with a high degree of precision is needed in manufacturing. A need exists to obtain the accuracy of scribing objects with a 3-axis machine that has typically required used of a 5-axis machine. The present invention attempts to address is deficiency in the prior systems.

The present invention attempts to address the existing limitations in providing a vector scribe tool for a 3-axis computer-controlled milling machine according to the principles and example embodiments disclosed herein.

### SUMMARY

In accordance with the present invention, the above and other problems are solved by for providing a vector scribe tool for a 3-axis computer-controlled milling machine.

In one embodiment, the present invention is a vector scribe tool for a computer-controlled milling tool. The vector scribe tool is constructed with a shaft having a top end for insertion into a collet of a computer numerical controlled milling machine, a retaining collar coupled to a bottom end of the shaft having one or more set screws, and a scribe tool having a tip of the tool capable of scribing an object. The scribe tool is held within the retaining collar using the one or more set screws, and the tip of the tool is positioned at an intersection of a centerline through the retaining collar and a centerline of the top of the tool when inserted into the collet of a computer numerical controlled milling machine.

The great utility of the invention is that an article of manufacture may provide for providing a vector scribe tool for a 3-axis computer controlled milling machine that would otherwise require a 5-axis milling machine.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment a CNC milling machine with a vector scribe tool according to the present invention.

FIG. 2 illustrates an embodiment of a vector scribe tool useful with a 3-axis CNC milling tool according to the present invention.

FIG. 3 illustrates another embodiment of a vector scribe tool useful with a 3-axis CNC milling tool according to the present invention.

FIG. 4 illustrates an embodiment of a vector scribe tool in use with a 3-axis CNC milling tool according to the present invention.

FIG. 5 illustrates another embodiment of a vector scribe tool according to the present invention.

### DETAILED DESCRIPTION

This application relates in general an article of manufacture for providing a scribe tool for a 3-axis computer-controlled milling tool. This tools primary function is to be used on a 3 axis CNC machine but it can also be used on a 5 axis machine to scribe hard to reach areas like the bottom of an object.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of objects structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “user” and “machinist” refers to an entity, e.g. a human, that operates a 3-axis computer-controlled milling tool according to the present invention in order to bring about a desired effect or outcome, particularly provide the user an ability to support an instrument. In a particular case, the user is one that uses for a scribe tool for a 3-axis computer-controlled milling tool. For such a user, the terms “user” and “machinist” may be used herein interchangeably.

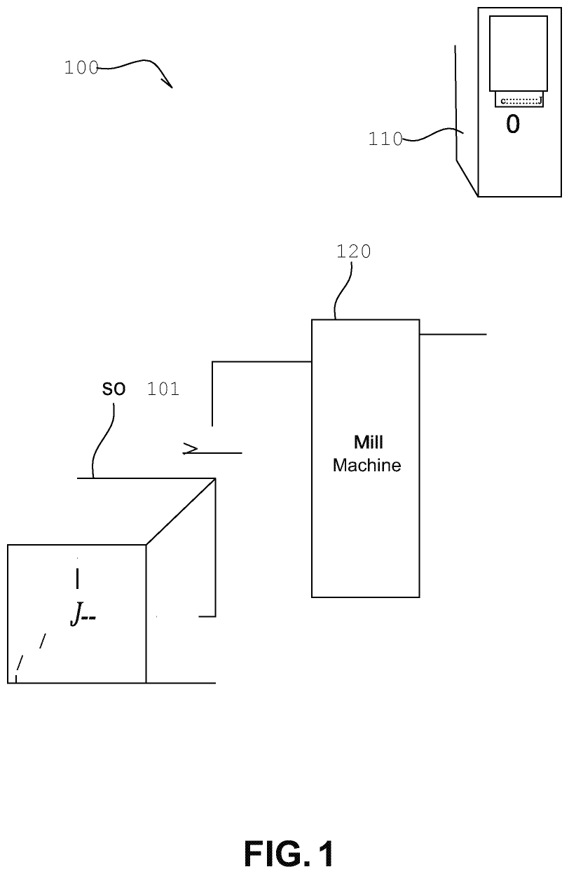

In general, the present disclosure relates general an article of manufacture for providing a scribe tool for a 3-axis computer-controlled milling tool. To better understand the present invention, FIG. 1 represents one potential embodiment of general an article of manufacture for providing a scribe tool for a 3-axis computer-controlled milling tool according to the present invention.

A Vector scribe is a machining tool that can scribe a straight line, vectored line, shape, or connect two lines anywhere on the vertical or horizontal surface of a part using a 3-axis CNC milling machine. It can also be pivoted to follow the contour of the part itself while scribing. A normal scribe can only scribe horizontal surfaces with minimum contour ability, but with the Vector scribe tool. You can now reach vertical surfaces of a part and scribe perfect lines anywhere on the sidewalls or top of the part without the use of a 5-axis machine with a pivoting head. The tip of the scribe is perfectly calibrated to the center of the tool making scribe lines accurate within thousands of an inch.

The tool fits in a generic ⅝″ size collet and tool holder that can be used on any 3-axis CNC machine. This tool with its carbide scriber can scribe on the toughest of materials. Hardened steel, Steel, Kirksite, Aluminum, Plastics, Ren, wood, glass. Pretty much anything.

FIG. 1 illustrates one potential embodiment a CNC milling tool with a scribe tool according to the present invention. A CNC milling machine 120 is connected to and controlled by a processing system 110 to direct any milling tool 101 to desired positions on a milled object 50. Programming in the processing system 110 calculates positions and movement for the tool 101 to remove material from the milled object 50 or to scribe a line on the milled object 50.

In the embodiment of FIG. 1, the CNC milling machine 120 is a 3-axis machine in that the machine, acting under computer 110 control, is capable of moving to a point in space defined by an x-axis, a y-axis, and a z-axis. Using the milling tool 101 of the present invention, scribing a line, marking, or the like may be created on the milled object 50 simply by moving the tool 101 to be in contact with the milled object 50 and a desired location and then moved the tool 101 to another location on the surface of the milled object 50. The movement of the tool 101 while in the contact with milled object 50 will scribe a mark as instructed.

Prior milling machines that could make such marks typically required use of a 5-axis milling machine that controlled an angular roll and an angular pitch of the milling tool 101 in addition to the x-axis, a y-axis, and a z-axis position. The shape and orientation of the milling tool 101 of the present invention described herein makes the need for the two additional axis of control unnecessary.

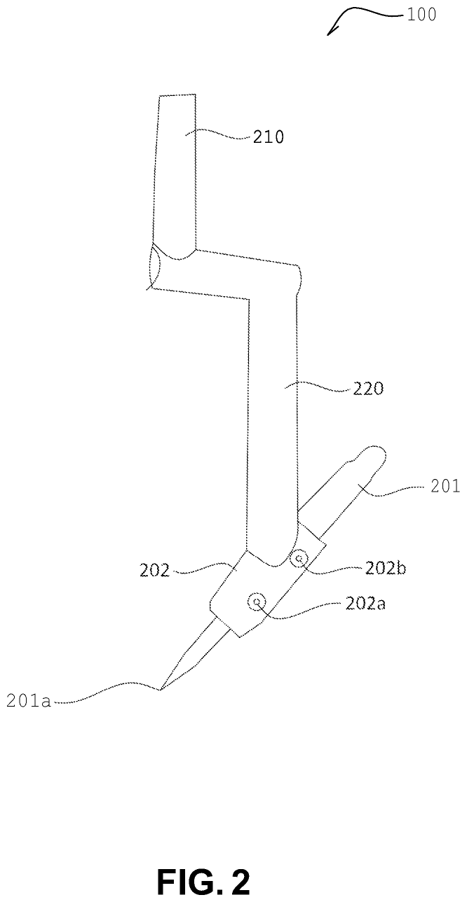

FIG. 2 illustrates an embodiment of a vector scribe tool 100 useful with a 3-axis CNC vector scribe tool according to the present invention. The vector scribe tool 201 is inserted into a retaining collar 202 that holds the vector scribe tool 201 at a known position relative to the top of the milling tool 210 at a predefined angle.

There are two ways of aligning the tip of the scribe to the center of the shaft. The first is to check it in x and y manually with an indicator. The second way is to use a preset check pit to locate it to the center. Once the scribe is properly located it is tightened down using the set screws 202a-b. The tip of the tool location 201a is determined by the machine by lowered the tool down to a block placed on the table. Touching the tip of the tool 201a to that block and zeroing out the machine in Z axis will tell the machine exactly where the tip of that tool is in space.

The top of the tool 210 is a ⅝″ diameter shaft for insertion and retention into a standard sized collet. In the embodiment of the tool from the collet insertion to scribe tool 201 is a ¾″ series of shaft members 220 arranged into a position that permits the tip 201a of the scribe tool 201 to be located directly below the collet insertion location 210 at a predefined location. A tool retention collar 202 is coupled to the lower end of the shaft members 220 that holds a scribe tool 201. Retention bolts 202a-b tighten the collar 202 around the scribe tool 201 at an adjustable position that permits the tip 201a of the tool 201 to be located at a known position by the milling machine 120. The scribe tool 201 is a ⅜″ member with a point 201a at one end capable of scribing marks into milled object s 50.

The arrangement of the shaft members 220 are shown in an example set of lengths and orientations. Many different sets of arrangements of shafts may be utilized to locate the scribe tool 201 within the retention collar 202 as a known position and orientation usable by the software in the CNC milling machine.

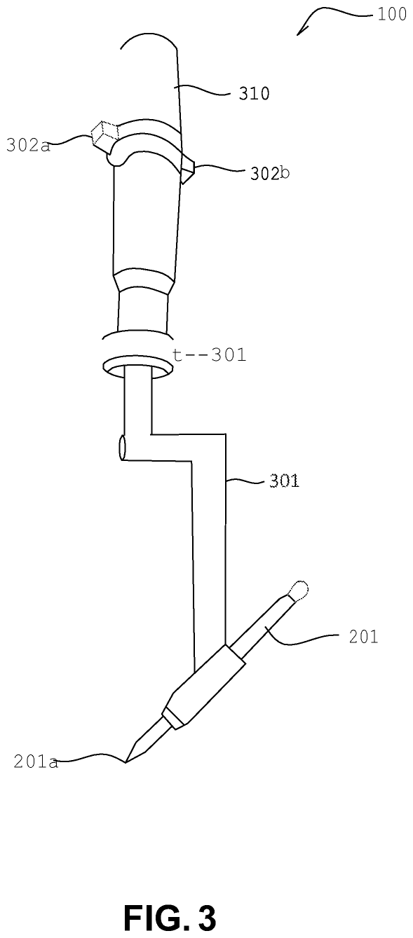

FIG. 3 illustrates another embodiment of a vector scribe tool useful with a 3-axis CNC vector scribe according to the present invention. The Vector Scribe is first put into a ⅝ collet. Next the collet along with the tool is inserted into 301. 301 is then tightened down with a wrench locking the scribe into the col let and tool holder. It than all becomes one piece. 310 is inserted into the CNC machine, 302a and 302b is the part of the tool holder that locks it all into the CNC machine.

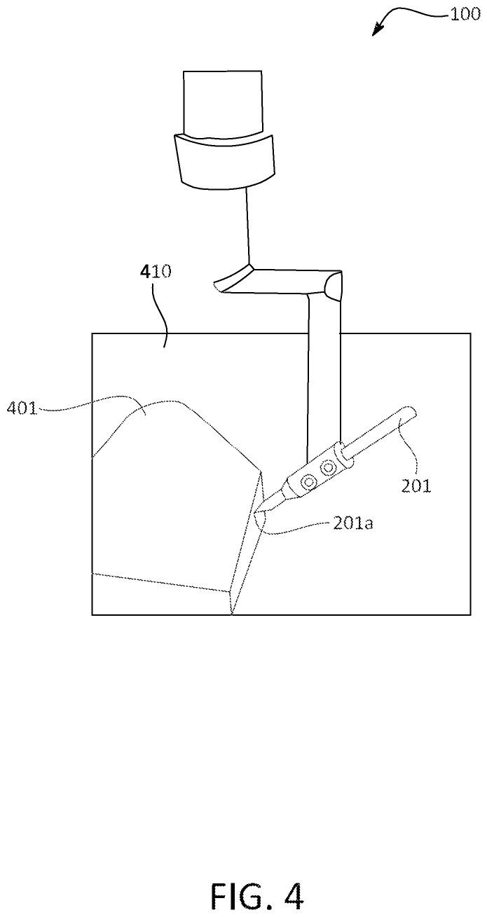

FIG. 4 illustrates an embodiment of a vector scribe tool in use with a 3-axis CNC vector scribe according to the present invention. Object 401 will be fastened to the table 410 using clamps or locked in a vice. This object will then be picked up by the machine using x and y coordinates. This will tell the machine the objects exact location on the table.

The Vector Scribe tool 100 will be inserted into the machine using the collet and tool holder. The tip of the vector scribe tool 201 is then lowered and picked up off of a block on the table telling the machine tip of tools exact location in Z axis. The program will then be loaded into the machine and you are ready to scribe.

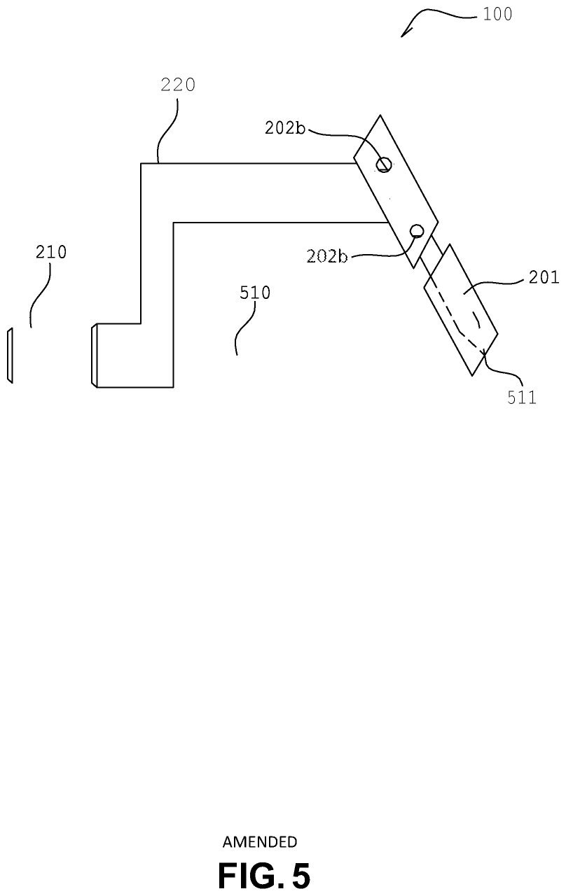

FIG. 5 illustrates another embodiment of the vector scribe tool 100 according to the present invention. The tool 100 contains a collet 210, shaft 220, retaining collar 202 having one or more set screws 202a-b, and a scribe too 201. The tip of the scribe tool 201a is calibrated as discussed above such that the tip of the scribe tool 201a is located along a center line 510 directly down from the center of top of the tool 210. Software running in the CNC milling machine 120 may calculate the position of the tip of the scribe tool 201a from a known position of the collet holding the top of the tool 210. All other dimensions of one embodiment of the vector scribe tool 100 are shown in detail within FIG. 5.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A vector scribe tool for a computer-controlled vector scribe, the scribe tool comprises:
a shaft having a top end for insertion into a collet of a computer numerical controlled milling machine;
a retaining collar coupled to a bottom end of the shaft having one or more set screws;
and a scribe tool having a tip of the tool capable of scribing an object;
wherein the scribe tool is held within the retaining collar using the one or more set screws; and
the tip of the tool is positioned at an intersection of a centerline through the retaining collar and a centerline of the top of the tool when inserted into the collet of a computer numerical controlled milling machine.

2. The vector scribe tool according to claim 1, wherein the retaining collar is position at a 45° angle between the centerline through the retaining collar and the centerline of the top of the tool.

3. The vector scribe tool according to claim 2, wherein the shaft comprises a plurality of straight segments joined at 90° angle such that the tip of the tool may be adjusted along the center line of the retaining collar.

4. The vector scribe tool according to claim 1, where the computer numerical controlled milling machine corresponds to a 3-axis controlled milling machine.

5. The vector scribe tool according to claim 1, where the computer numerical controlled milling machine corresponds to a 5-axis controlled milling machine.
